(19) United States
(12) Patent Application Publication
(10) Pub. No.: US 2026/0165236 A1
(43) Pub. Date: Jun. 18, 2026

(54) FIRE RAKE

(71) Applicant: CAMELOT TOOLS LLC, Holden, MA (US)

(72) Inventor: Antonio E. Cacela, Holden, MA (US)

(21) Appl. No.: 19/389,318

(22) Filed: Nov. 14, 2025

Related U.S. Application Data
(60) Provisional application No. 63/734,825, filed on Dec. 17, 2024.

(51) Int. Cl. A01D 7/02; B25G 3/26; B25G 3/38

(52) U.S. Cl. CPC A01D 7/02; B25G 3/26; B25G 3/38

(57) ABSTRACT

An adjustable fire rake includes an elongated handle and a rake head pivotally coupled to the handle. The rake head includes a collar portion secured to an end of the handle and a rake portion adjustably coupled to the collar portion. The fire rake portion of the rake further includes a semi-circular guide having several openings formed in the guide along an outer edge of the guide. The collar portion includes a spring-loaded pin to secure the collar in a desired position with respect to the rake portion.

### CROSS-REFERENCE TO RELATED APPLICATION

This application claims the benefit under 35 U.S.C. § 119(e) of co-pending U.S. Provisional Patent Application No. 67/734,825 titled FIRE RAKE filed on December 17, 2024, which is herein incorporated by reference in its entirety for all purposes.

### BACKGROUND OF THE DISCLOSURE

Firefighters use fire rakes to prevent the destruction created by forest fires. A typical fire rake includes a wooden or fiberglass handle and a fixed rake head having multiple sharp, serrated, triangular steel blades. In one application, the fire rake can be used to rake a fire break with the sharp teeth of the fire rake enabling the fire rake to reach the fire in the forest undergrowth in addition to loosening surface debris. The fire rake also can be used to break apart vegetation for access by other implements. Existing fire rakes are often cumbersome to store, transport, or carry in confined areas such as fire engines or helicopters because the rake head is fixed relative to the handle. A firefighter may need to carry multiple tools with limited storage capacity. Additionally, a fixed head configuration can make the tool awkward to use on uneven or sloped terrain. There remains a need for an improved fire rake that combines the durability and strength of a fixed steel head with the flexibility of an adjustable, foldable design that allows for quick reconfiguration and compact storage.

### SUMMARY OF THE DISCLOSURE

One aspect of the present disclosure is directed to a fire rake comprising an elongated handle and a rake head pivotally coupled to the handle. The rake head includes a collar portion secured to an end of the handle and a rake portion adjustably coupled to the collar portion.

Embodiments of the fire rake further may include configuring the rake portion with a body having a plurality of teeth spaced along an edge of the body and angled inwardly with respect to a plane of the body. Each tooth of the plurality of teeth may include a sharp, triangularly-shaped contour. The collar portion may be pivotally secured to the rake portion by a pivot pin. The rake portion may be configured to pivot with respect to the collar portion and the handle from positions in which the rake portion is parallel to the collar portion and the handle to a position in which the rake portion is perpendicular to the collar portion and the handle.

The rake portion may include the semi-circular guide having several openings formed in the guide along an outer edge of the guide. The collar portion may include a spring-loaded pin to secure the collar in a desired position with respect to the rake portion. When the rake portion is in a desired position with respect to the collar portion, the spring-loaded pin may be aligned with an opening and the spring-loaded pin may enter the opening to secure the rake portion in the desired position with respect to the collar portion and the handle. The elongated handle may be fabricated from wood or fiberglass, and may be 60 inches in length. The rake head may be fabricated from heat-treated carbon steel.

One aspect of the present disclosure is directed to a fire rake comprising an elongated handle and a rake head pivotally coupled to the handle. The rake head includes a collar portion secured to an end of the handle and a rake portion adjustably coupled to the collar portion.

Embodiments of the fire rake further may include configuring the rake portion with a body having a leading edge with a plurality of teeth spaced along the leading edge of the body and angled inwardly with respect to a plane of the body. Each tooth of the plurality of teeth may include a sharp, triangularly-shaped contour. The body further may include a trailing edge opposite the leading edge, the leading edge embodying a serrated cutting edge and the trailing edge embodying a straight scraping edge, the leading edge and the trailing edge being configured for alternative raking and clearing functions, respectively. The collar portion may be pivotally secured to the rake portion by a pivot pin. The rake portion may be configured to pivot with respect to the collar portion and the handle from positions in which the rake portion is parallel to the collar portion and the handle to a position in which the rake portion is perpendicular to the collar portion and the handle and to one or more intermediate positions. The rake portion may include a semi-circular guide having several openings formed in the guide along an outer edge of the guide. The collar portion may include a spring-loaded pin to secure the collar in a desired position with respect to the rake portion. When the rake portion is in a desired position with respect to the collar portion, the spring-loaded pin may be aligned with an opening of the several openings, with the spring-loaded pin entering the opening to secure the rake portion in the desired position with respect to the collar portion and the handle. The spring-loaded pin may be biased to be received by the opening by a compression spring housed within the collar portion. The semi-circular guide may include seven equally spaced openings, with each opening defining a discrete angular position of the rake portion relative to the handle. The elongated handle may be fabricated from wood or fiberglass, and is 60 inches in length. The rake head may be fabricated from heat-treated carbon steel.

Another aspect of the present disclosure is directed to a fire rake head comprising a collar portion configured to be secured to a handle and a rake portion pivotally attached to the collar portion by a pivot mechanism having a pivot pin positioned at a center of curvature of a semi-circular guide.

Embodiments of the fire rake head further may include a spring-loaded pin assembly configured to engage one opening of a plurality of openings formed along an outer edge of the semi-circular guide to lock the rake portion at a selected angular position for use or for folding into a compact storage configuration. The semi-circular guide may include seven openings equally spaced along the outer edge. Each opening may be configured to receive the spring-loaded pin that is biased toward the opening when the rake portion reaches a selected angular position. The spring-loaded pin may be biased toward the opening by a compression spring disposed within the collar portion and retained by a removable cap. The spring-loaded pin may include a pull knob to retract the spring-loaded pin against a spring bias to manual adjust the rake head angle. The rake portion may be lockable at angles between 0˚and 120˚ relative to the collar portion to accommodate level, sloped, or vertical terrain conditions. The rake portion may include mirrored halves about a central axis extending through the pivot pin so that the pivot mechanism is symmetrically balanced. The collar portion further may include a housing that retains the spring-loaded pin assembly, the housing terminating in an opening aligned with the semi-circular guide. The pivot pin and spring-loaded pin assembly may be configured such that the pivot pin defines a fixed rotational axis about which the rake portion rotates, and the spring-loaded pin selectively engages an opening of the plurality of openings to lock the rake portion against further rotation.

Yet another aspect of the present disclosure is directed to a method of storing a fire rake comprising: disengaging a spring-loaded pin from one of a plurality of openings along a semi-circular guide of a rake portion; rotating the rake portion about a pivot pin connecting the rake portion to a collar portion at an end of a handle; and folding the rake portion from a usable position in which the rake portion is perpendicular to the handle to a storage position in which the rake portion is parallel to the handle.

### BRIEF DESCRIPTION OF THE DRAWINGS

The accompanying drawings are not intended to be drawn to scale. In the drawings, each identical or nearly identical component that is illustrated with various figures, is represented by a line numeral. For purposes of clarity, not every component may be labeled in every drawing. In the drawings:

FIG. 1 is a perspective view of an embodiment of a fire rake;

FIG. 2 is an enlarged top perspective view of the fire rake;

FIG. 3 is a front view of the fire rake;

FIG. 4 is a back view of the fire rake;

FIG. 5 is a side view of the fire rake;

FIG. 6 is an opposite side view of the fire rake;

FIG. 7 is a top view of the fire rake;

FIG. 8 is a bottom view of the fire rake;

FIG. 9 is an enlarged bottom perspective view of the fire rake;

FIG. 10 a front view of the fire rake showing the fire rake in an angled position; and

FIG. 11 is a front view of the fire rake showing the fire rake in a folded position.

### DETAILED DESCRIPTION OF THE DISCLOSURE

Aspects of the present disclosure are directed to an adjustable fire rake having a folding rake head to facilitate the convenient storage and effortless transport of the fire rake. The rake head can be set to multiple angles of use to adapt to any situation. From clearing brush to creating firebreaks, the adjustable fire rake enables fire fighters to combat wildfires with precision and efficiency.

In one embodiment, the rake head of the adjustable fire rake includes multiple teeth, e.g., five teeth, which are angled inwardly with respect a body of the rake head. The adjustable fire rake is particularly configured to gather debris and controls embers, thereby enhancing the ability of the adjustable fire rake to contain and extinguish forest wildfires. In one embodiment, the adjustable fire rake includes an extended 60-inch handle to enable the adjustable fire rake to be used comfortably without compromising on control.

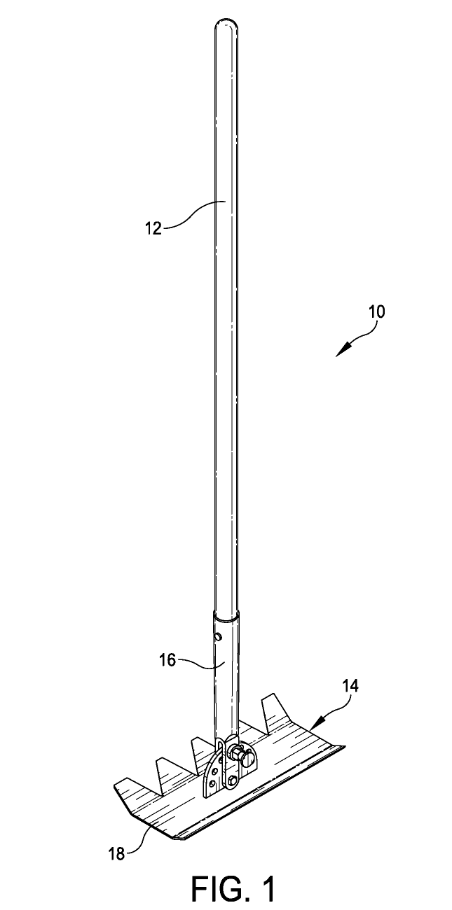

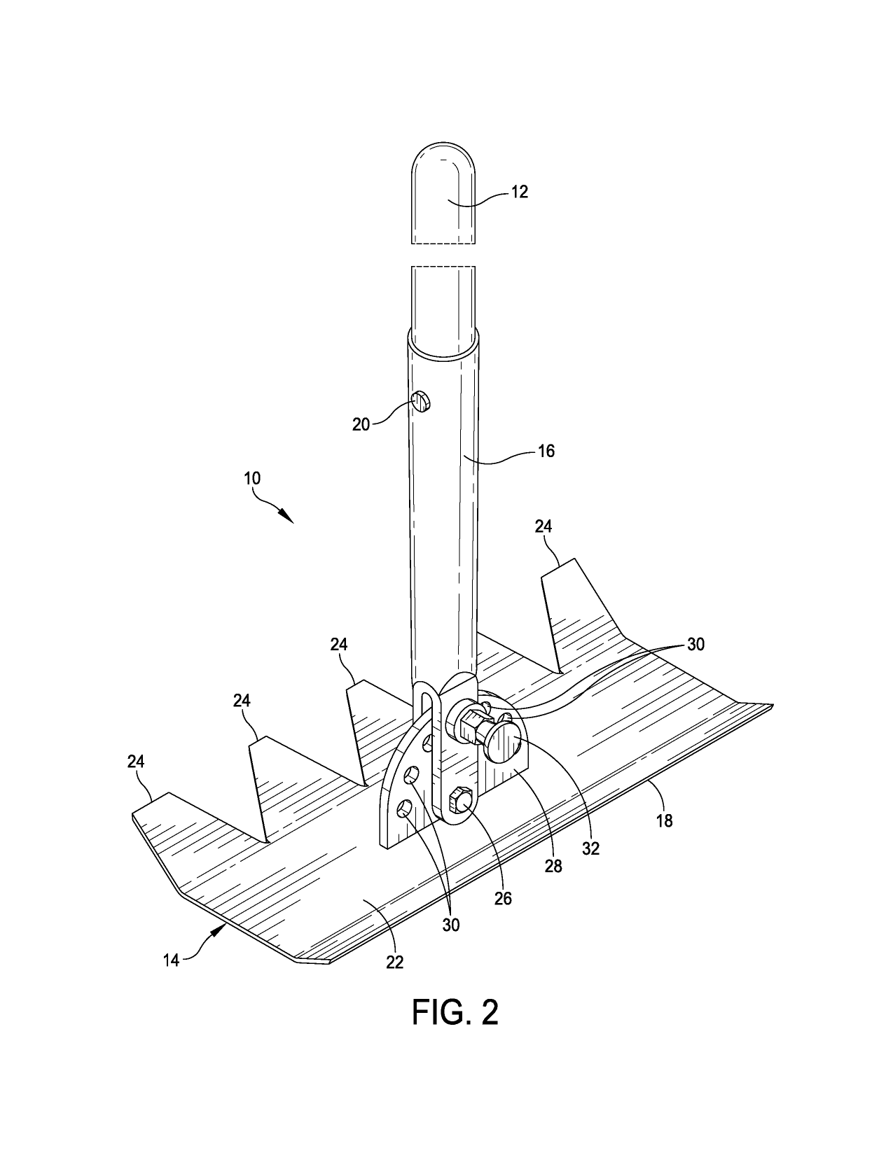

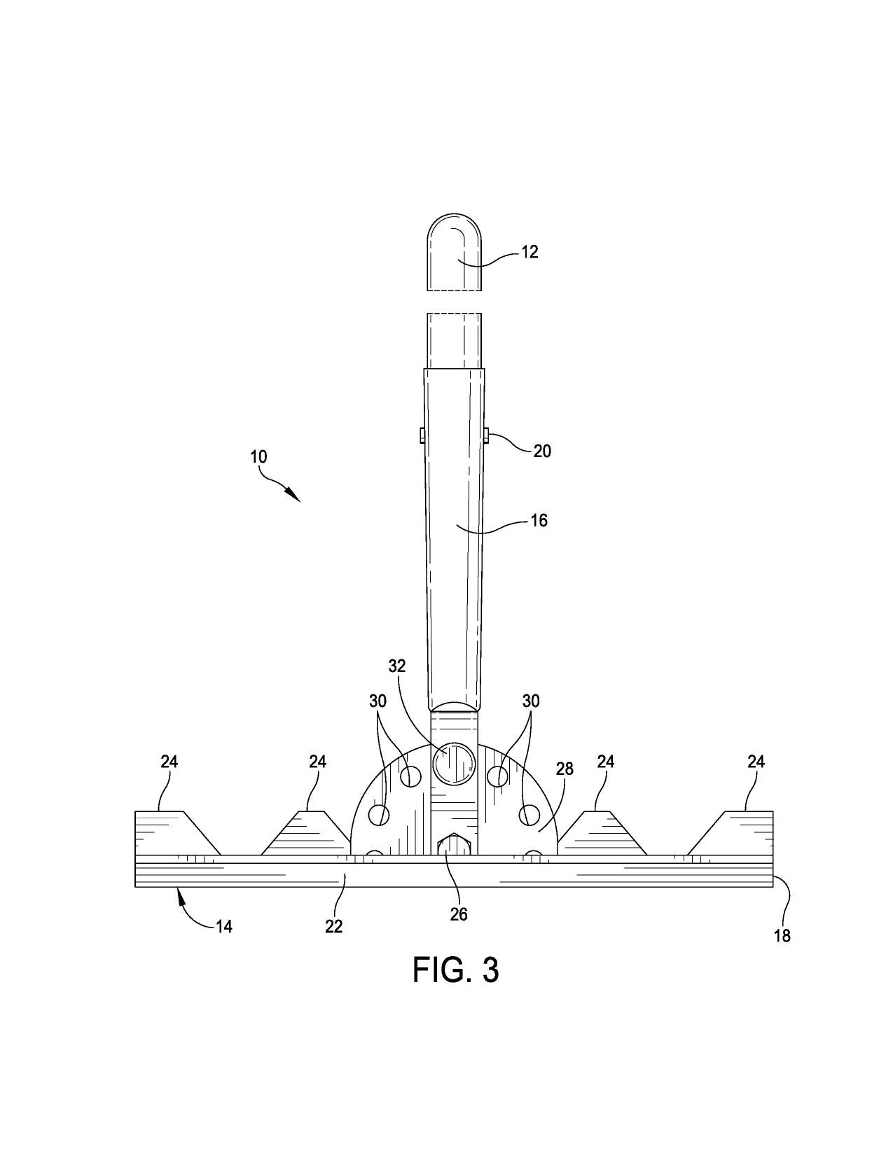

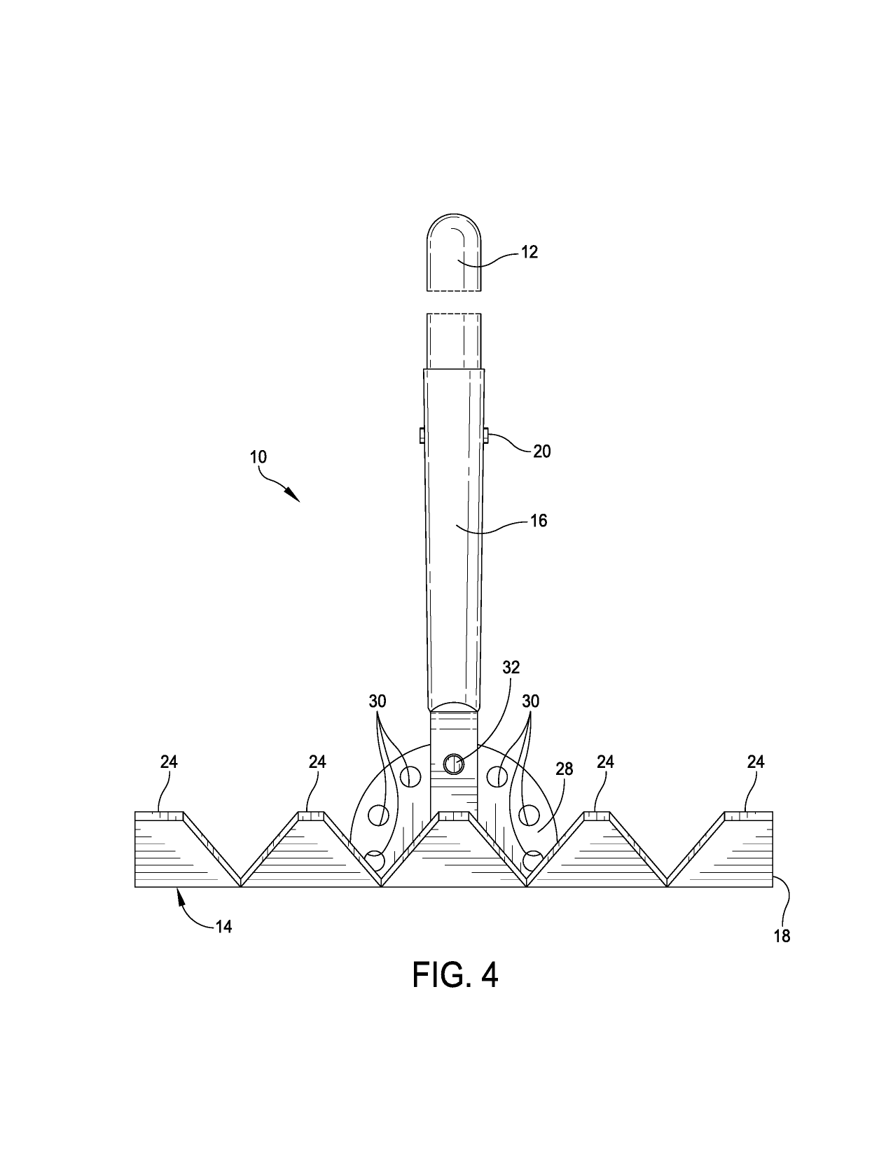

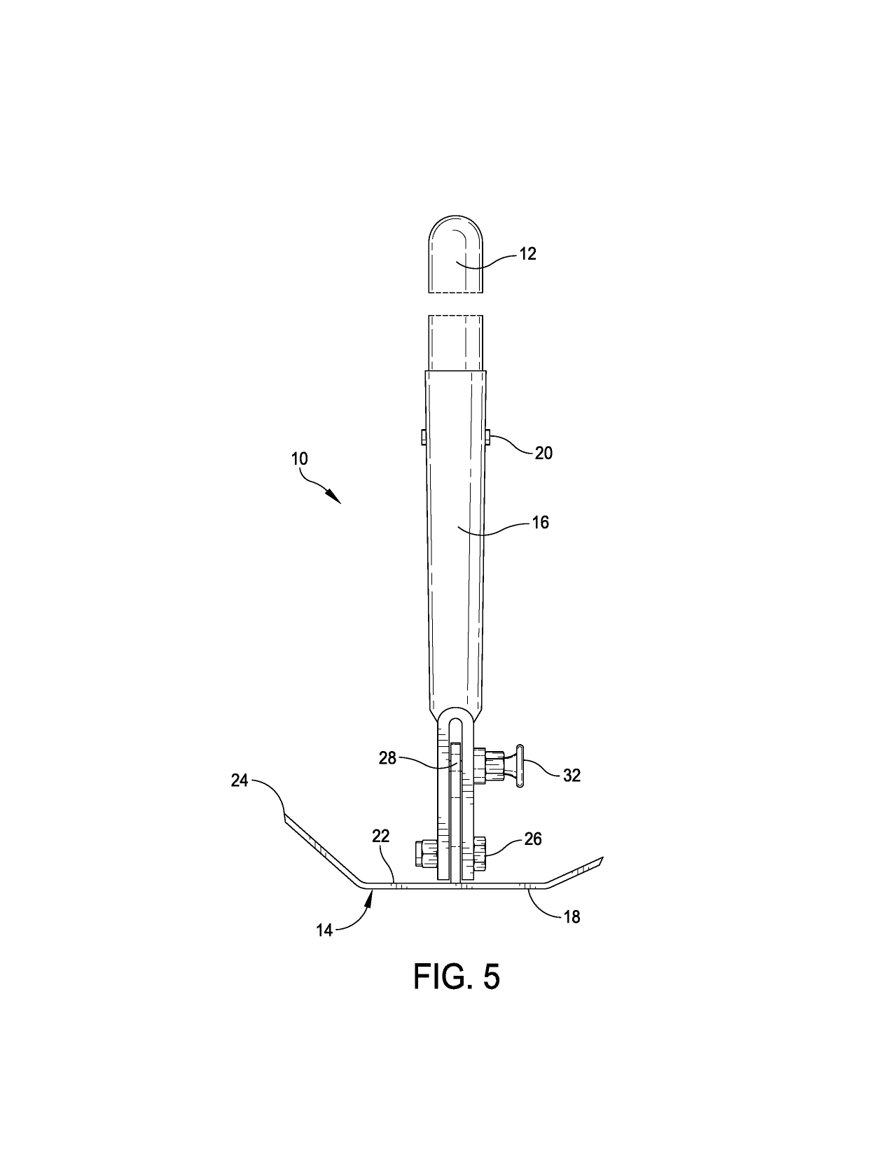

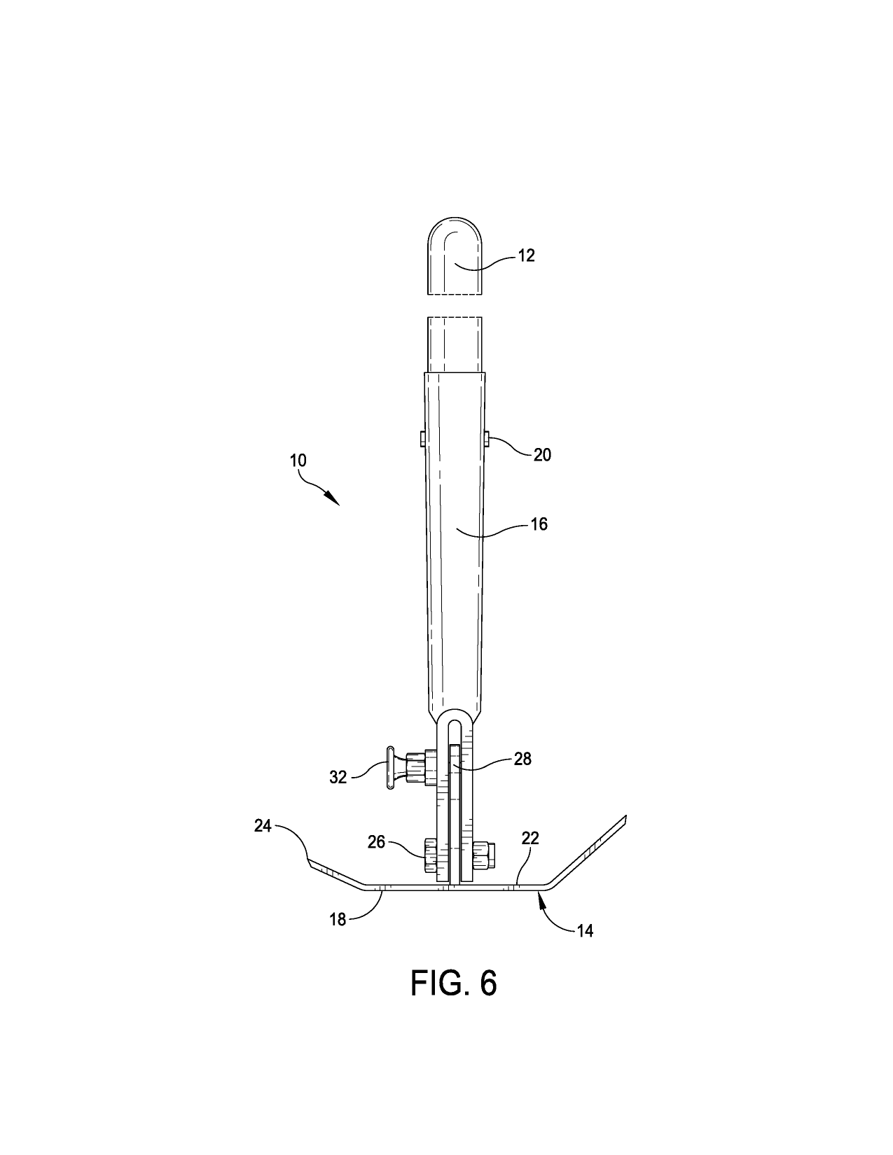

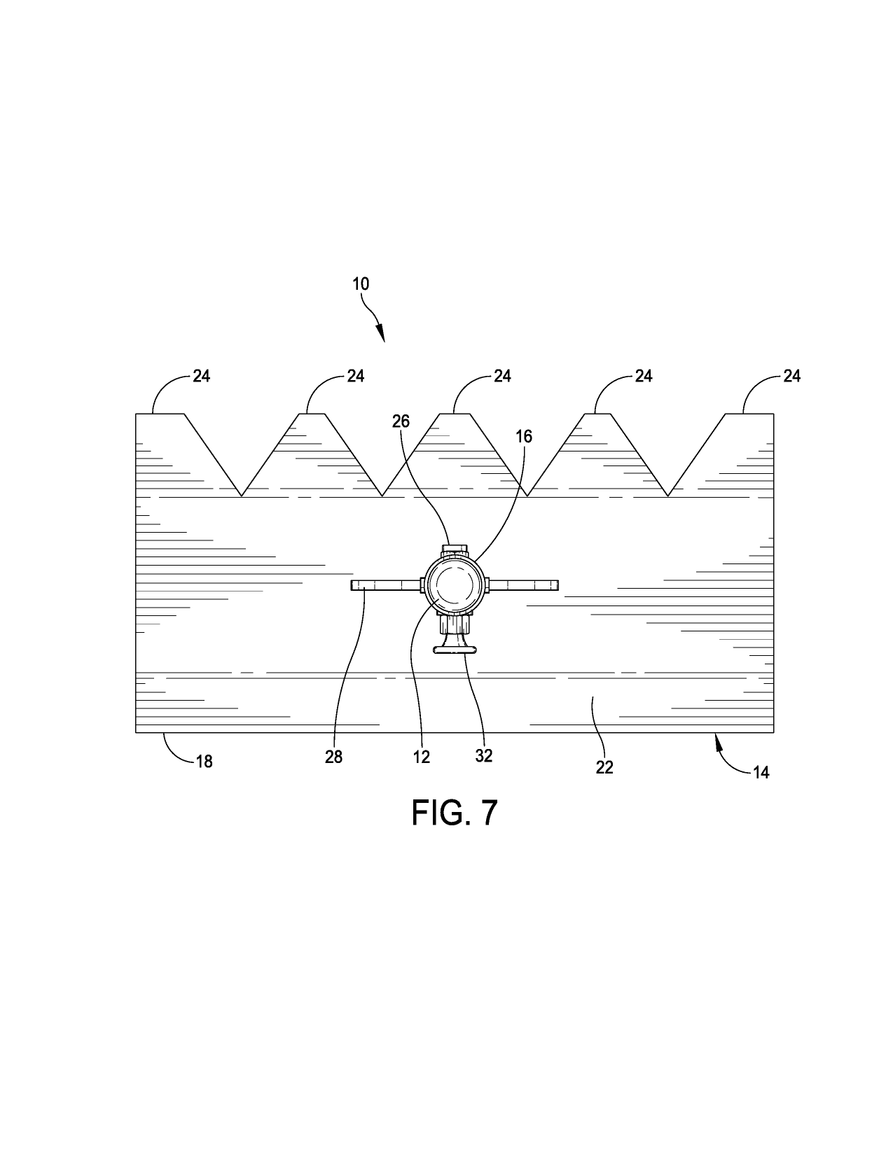

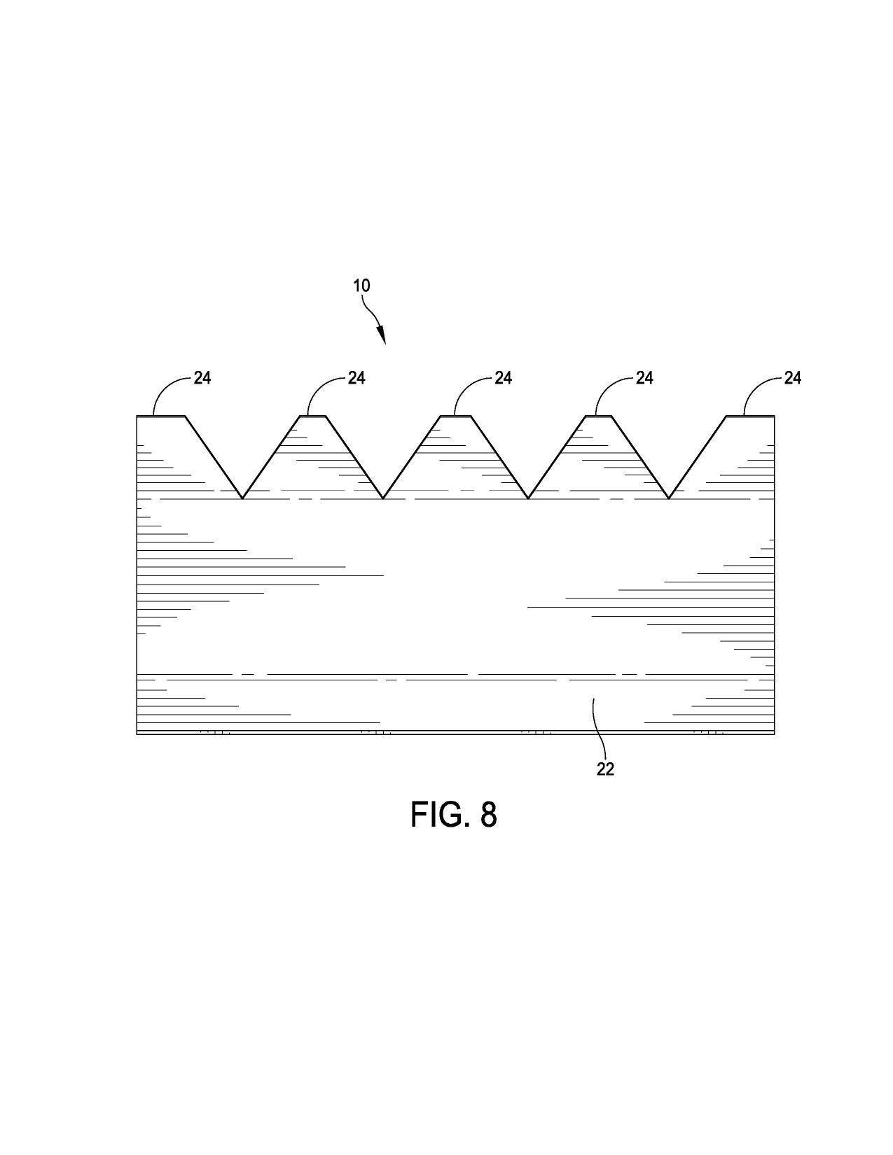

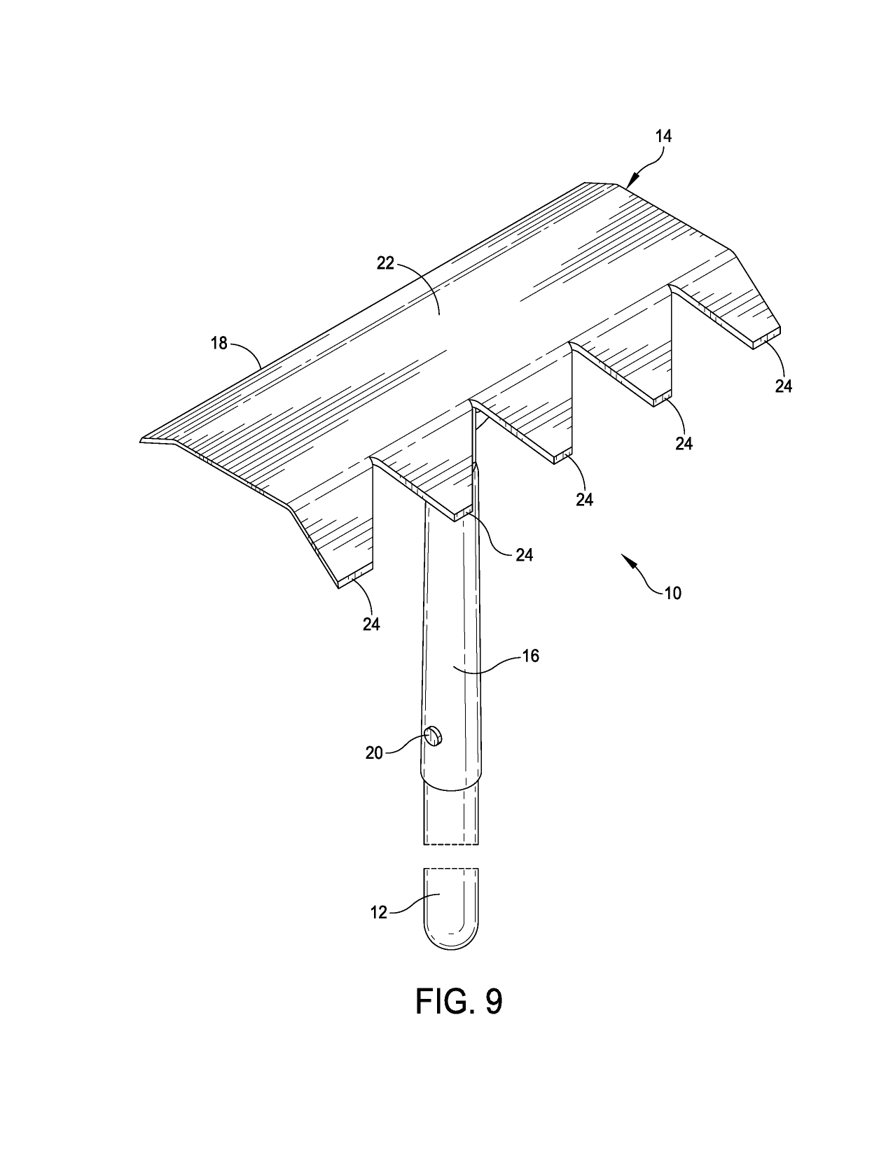

Referring to the drawings, and more specifically to FIGS. 1-9, an adjustable fire rake of an embodiment of the present disclosure is generally indicated at 10. As shown, the adjustable fire rake 10 includes an elongated handle 12, which can be fabricated from wood or fiberglass. In one embodiment, as best shown in FIG. 1, the handle 12 can be 60 inches in length and the diameter of the handle 12 can be selected so that it is easy to grip. The length of the handle 12 can be selected to any desired length to accommodate a particular user.

The adjustable fire rake 10 further includes a rake head, generally indicated at 14, secured to the handle 12. The rake head 14 includes a collar portion 16, which is secured to an end of the handle 12, and a rake portion 18 adjustably coupled to the collar portion 16. The collar portion 16 is secured to the end of the handle 12 in a typical manner with the end of the handle 12 being inserted into a cylindrical opening of the collar portion 16. In one embodiment, the collar portion 16 can be staked to the handle 12 by a pin or screw fastener 20 to securely retain the handle 12 within the cylindrical opening of the collar portion 16.

The rake portion 18 includes a body 22 having several teeth, each indicated at 24, spaced along an edge of the body 22 and angled inwardly with respect to a plane of the body 22. In the shown embodiment, there are five teeth 24 provided along the edge of the body 22, each tooth 24 having a sharp outer edge with a triangularly-shaped contour. The number and shape of the teeth 24 may be varied depending on the intended use of the adjustable fire rake 10. The components of the rake head 14 including the collar portion 16 and the rake portion 18 can be fabricated from heat-treated carbon steel or any other suitable material. The rake portion 18 may be reversible, providing sharp teeth along one side, e.g., a leading edge side of the body 22, and a straight scraping edge along the opposite side, e.g., a trailing edge side of the body 22, thereby allowing the user to flip or reposition the head for different functions.

The rake portion 18 is adjustable with respect to the collar portion 16 and the handle 12. In one embodiment, the collar portion 16 is pivotally secured to the rake portion 18 by a pin or some other suitable structure, such as a bolt and nut fastener, indicated at 26. Specifically, the pin or bolt 26 extends through aligned openings formed in the collar portion 16 and a semi-circular guide 28 that extends perpendicularly from the body 22 of the rake portion 18. Thus, the rake portion 18 is able to pivot with respect to the collar portion 16 and the handle 12 from positions in which the rake portion 18 is parallel to the collar portion 16 and the handle 12 (a folded position) to a position in which the rake portion 18 is perpendicular to the collar portion 16 and the handle 12. The pivot pin 26 passes through the center of curvature of the semi-circular guide 28, allowing rotation along a fixed axis. Flat washers, bushings, or sleeve bearings may be placed between the collar and guide to minimize friction and wear. The pivot pin 26 may be a hardened steel fastener retained by a locknut or cotter pin.

To secure the position of the rake portion 18 to the collar portion 16, the rake portion 18 includes the semi-circular guide 28 having several openings, each indicated at 30, formed in the guide 28 along an outer edge of the guide 28. In the shown embodiment, the guide 28 includes seven openings 30 formed therein. The collar portion 16 includes a spring-loaded pin 32 to secure the collar portion 16 in a desired position with respect to the rake portion 18. Specifically, when in the desired position, the spring-loaded pin 32 is aligned with an opening 30 of the guide 28 and the spring-loaded pin 32 enters the opening 30 to secure the rake portion 18 in the desired position with respect to the collar portion 16 and the handle 12.

In one embodiment, the collar portion 16 is configured to define a transverse bore oriented radially toward the semi-circular guide 28. The spring-biased locking pin 32 is slidably received within the bore, with its forward end projecting through an aperture in the collar wall of the collar portion 16 to be received within one opening 30 of the guide openings 30. The spring-loaded pin 32 may include a compression spring to urge the pin 32 toward the semi-circular guide 28 and a pull knob or ring to allow manual retraction of the pin 32. The bore may be closed by a removable threaded cap or press-fit retainer to contain the spring assembly and protect it from debris. The bore and pin are coaxially aligned with the openings 30 to ensure smooth engagement and release.

The semi-circular guide 28 includes a smooth arcuate plate welded or riveted to the rake body 22. As noted above, the outer edge of the semi-circular guide 28 defines a uniform series of circular openings 30 positioned along a common radius centered on the pivot pin 26. The inner edge of the semi-circular guide 28 terminates in a mounting flange secured to the rake body to maintain concentric alignment. The semi-circular guide 28 subtends an arc of approximately 120˚, corresponding to the available adjustment range of the rake portion 18. The outer rim of the semi-circular guide 28 may be rolled or thickened to improve stiffness and to guide the spring-loaded pin 32 during engagement. The openings 30 may be chamfered to facilitate insertion of the spring-loaded pin 32.

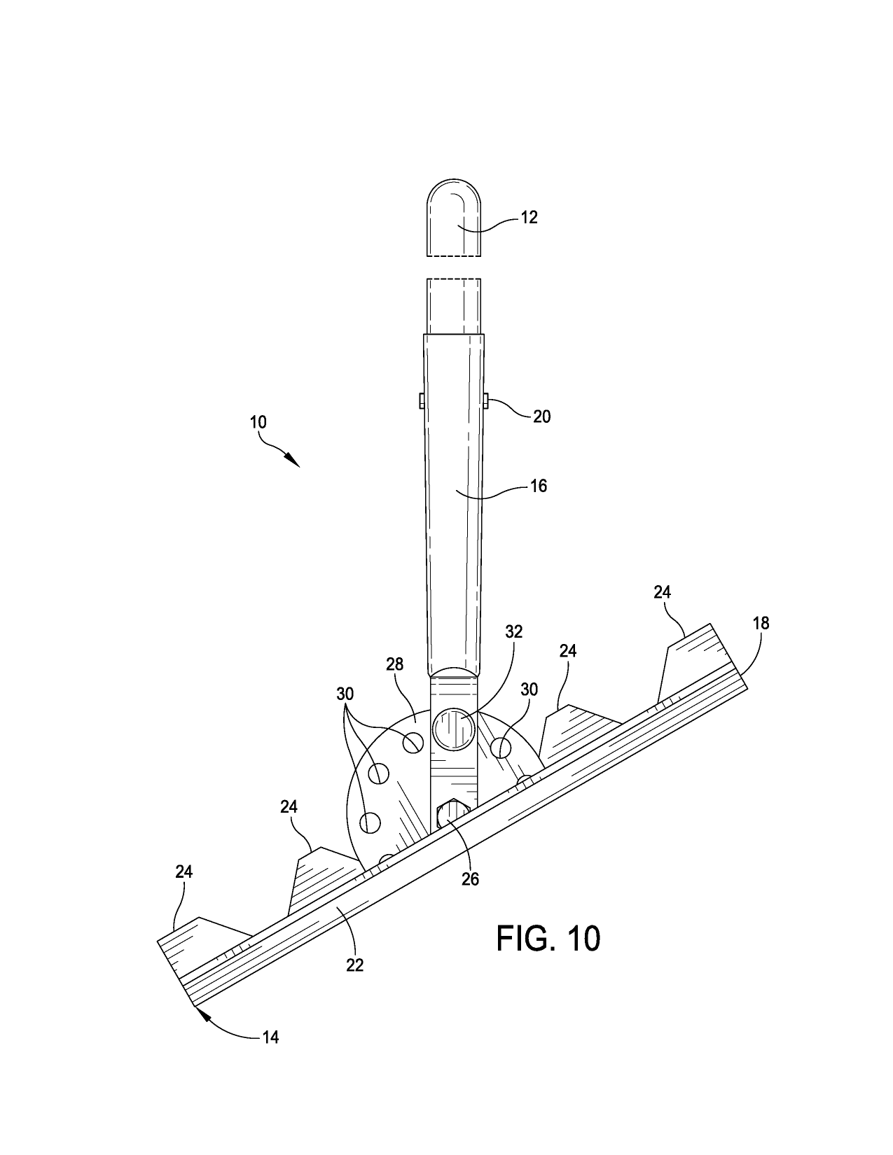

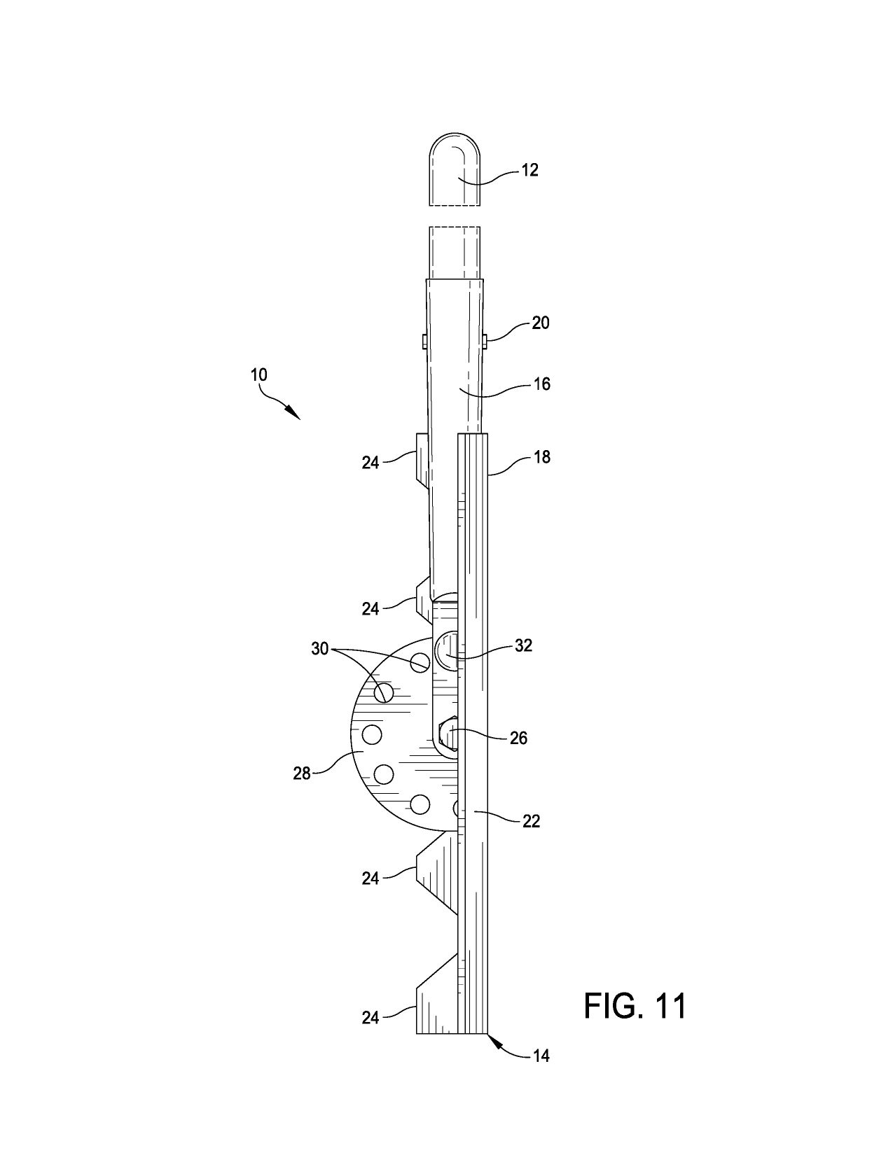

FIGS. 1-9 represent the adjustable fire rake 10 in a use position in which the rake portion 18 is generally perpendicular with respect to the collar portion 16 and the handle 12. Referring to FIGS. 10 and 11, the rake portion 18 is shown at different position with respect to the collar portion 16 and the handle 12. For example, FIG. 10 shows the rake portion 18 at a 60-degree angle with respect to the collar portion 16 and the handle 12. In this position, the fire rake 10 may be used on a sloped surface. FIG. 11 shows the rake portion 18 at a 0-degree angle with respect to the collar portion 16 and the handle 12. In this position, the fire rake 10 may be stowed or transported. The semi-circular guide 28 provides repeatable indexed angular positions between 0˚ and 120˚ and may include end stops to prevent over-rotation.

In some embodiments, the rotational range of the rake portion 18 may be limited by the terminal ends of the semi-circular guide 28 contacting corresponding portions of the collar 16, thereby preventing over-rotation.

When the adjustable fire rake 10 is in use, the semi-circular guide 28 transfers lateral and torsional forces from the rake portion 18 to the collar portion 16 through the pivot pin 26 and engaged opening 30. This configuration distributes impact loads evenly along the arc, reducing localized stress and preventing wobble or deflection at the joint. The semi-circular guide 28 thereby provides a stable yet adjustable connection that maintains rigidity during raking while allowing quick reorientation when desired.

In some embodiments, the adjustable fire rake 10 is capable of folding the rake portion 18 with respect to the collar portion 16 and the handle 12 in a storage/transport position.

In some embodiments, the adjustable fire rake 10 is capable of achieving one of several angles of use to optimize the functionality of the adjustable fire rake during use.

In some embodiments, the adjustable fire rake 10 includes several teeth 24 provided along the leading edge of the body 22 that are angled inwardly with respect to the body 22 of the rake portion 18.

In some embodiments, the handle 12 can be selected to achieve a desired length.

In some embodiments, each side of the rake head 14 may be a mirror image of the other about a central longitudinal axis passing through the pivot pin 26, thereby balancing lateral forces during raking. The openings 30 in the semi-circular guide 28 may be spaced at predetermined intervals to enable adjustment of an angle of the rake head 14. Stops or ribs can be formed adjacent to the outer edge of the plate to limit rotation and prevent over-extension. The spring-loaded pin 32 may include a compression spring housed with a recess of the collar portion 16, with a button or pull-pin actuator accessible to the user.

In some embodiments, the semi-circular guide 28 permits the rake portion 18 to rotate relative to the handle 12. The semi-circular guide 28 defines multiple openings 30, such as seven equally spaced openings 30, that correspond to distinct angular positions between the rake portion 18 and the handle 12. The spring-loaded pin 32 within the collar portion 16 engages one of these openings 30 to lock the rake portion 18 at a selected angle. The arrangement allows a user to quickly fold the rake head 18 parallel to the handle 12 for storage or transport and then deploy it perpendicularly for use.

In some embodiments, the edge profile of the teeth may be selected according to the specific terrain or debris to be managed. For instance, the teeth 24 along the leading edge may define sharp, serrated edges suitable for cutting through vegetation, roots, and compacted soil, or may instead define a straight or slightly curved scraping edge adapted for clearing ash, sand, or loose debris. Each tooth along the lead edge is configured to define a leading cutting edge and the trailing edge is configured to define a trailing relief face, which may terminate in either a pointed or flattened tip. A straight-edge along the trailing edge may be used when the tool is employed like a hoe or scraper, whereas the sharp or serrated teeth along the leading edge may be used to provide enhanced penetration for wildfire control. The rake body 22 may be configured such that either style of tooth can be substituted by bolted or welded modules.

In some embodiments, the semi-circular guide 28 may be integrally formed with the body 22 as an arcuate flange, while in other embodiments the semi-circular guide 28 may be a separate plate welded, riveted, or bolted to the body 22. The semi-circular guide 28 may subtend an arc of about 120˚ and comprise concentric inner and outer edges that define a uniform band thickness, with the pivot pin 26 positioned at the center of curvature. Each opening 30 can be chamfered or countersunk to enable reliable engagement by the spring-loaded pin 32.

In some embodiments, the collar portion 16 may be configured to define an interior cavity that houses the spring, pin guide, and user actuator, the cavity being sealed by a cap to resist ingress of dirt, ash, and moisture. The pivot pin 26 may be press-fit or threaded into the collar portion 16, with a bushing or washer stack between the collar portion 16 and semi-circular guide 28 to provide smooth rotation.

In some embodiments, the rake portion 18 of the rake head 14 can be fixed with respect to the collar portion 16 of the rake head 14, either by bolt fasteners or by welding. For example, the rake portion 18 of the rake head 14 can be fixed with respect to the collar portion 16 of the rack head 14 so that the rake portion is perpendicular with respect to the collar portion 16.

Embodiments are not limited in their application to the details of construction and the arrangement of components set forth in the following description or illustrated in the drawings. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the scope of the disclosure. Accordingly, the foregoing description and drawings are by way of example only.

1. A fire rake, comprising:
an elongated handle; and
a rake head pivotally coupled to the handle, the rake head including
a collar portion secured to an end of the handle, and
a rake portion adjustably coupled to the collar portion.

2. The fire rake of claim 1, wherein the rake portion includes a body having a leading edge with a plurality of teeth spaced along the leading edge of the body and angled inwardly with respect to a plane of the body.

3. The fire rake of claim 2, wherein body further includes a trailing edge opposite the leading edge, the leading edge embodying a serrated cutting edge and the trailing edge embodying a straight scraping edge, the leading edge and the trailing edge being configured for alternative raking and clearing functions, respectively.

4. The fire rake of claim 1, wherein the collar portion is pivotally secured to the rake portion by a pivot pin.

5. The fire rake of claim 4, wherein the rake portion is configured to pivot with respect to the collar portion and the handle from positions in which the rake portion is parallel to the collar portion and the handle to a position in which the rake portion is perpendicular to the collar portion and the handle and to one or more intermediate positions.

6. The fire rake of claim 4, wherein
the rake portion includes a semi-circular guide having several openings formed in the guide along an outer edge of the guide, and
the collar portion includes a spring-loaded pin to secure the collar in a desired position with respect to the rake portion.

7. The fire rake of claim 6, wherein when the rake portion is in a desired position with respect to the collar portion, the spring-loaded pin is aligned with an opening of the several openings, the spring-loaded pin entering the opening to secure the rake portion in the desired position with respect to the collar portion and the handle.

8. The fire rake of claim 7, wherein the spring-loaded pin is biased to be received by the opening by a compression spring housed within the collar portion.

9. The fire rake of claim 6, wherein the semi-circular guide includes seven equally spaced openings, each opening defining a discrete angular position of the rake portion relative to the handle.

10. The fire rake of claim 6, wherein the semi-circular guide includes seven equally spaced openings, each defining a discrete angular position of the rake portion relative to the handle.

11. A fire rake head, comprising:
a collar portion configured to be secured to a handle; and
a rake portion pivotally attached to the collar portion by a pivot mechanism having a pivot pin positioned at a center of curvature of a semi-circular guide.

12. The fire rake head of claim 11, further comprising a spring-loaded pin assembly configured to engage one opening of a plurality of openings formed along an outer edge of the semi-circular guide to lock the rake portion at a selected angular position for use or for folding into a compact storage configuration.

13. The fire rake head of claim 12, wherein each opening is configured to receive the spring-loaded pin that is biased toward the opening when the rake portion reaches a selected angular position.

14. The fire rake head of claim 12, wherein the spring-loaded pin is biased toward the opening by a compression spring disposed within the collar portion and retained by a removable cap.

15. The fire rake head of claim 12, wherein the spring-loaded pin includes a pull knob to retract the spring-loaded pin against a spring bias to manually adjust the rake head angle.

16. The fire rake head of claim 12, wherein the rake portion is lockable at angles between 0˚and 120˚ relative to the collar portion to accommodate level, sloped, or vertical terrain conditions.

17. The fire rake head of claim 12, wherein the rake portion includes mirrored halves about a central axis extending through the pivot pin so that the pivot mechanism is symmetrically balanced.

18. The fire rake head of claim 12, wherein the collar portion further includes a housing that retains the spring-loaded pin assembly, the housing terminating in an opening aligned with the semi-circular guide.

19. The fire rake head of claim 12, wherein the pivot pin and spring-loaded pin assembly are configured such that the pivot pin defines a fixed rotational axis about which the rake portion rotates, and the spring-loaded pin selectively engages an opening of the plurality of openings to lock the rake portion against further rotation.

20. A method of storing a fire rake, the method comprising:
disengaging a spring-loaded pin from one of a plurality of openings along a semi-circular guide of a rake portion;
rotating the rake portion about a pivot pin connecting the rake portion to a collar portion at an end of a handle; and
folding the rake portion from a usable position in which the rake portion is perpendicular to the handle to a storage position in which the rake portion is parallel to the handle.
